(19) United States
(12) Patent Application Publication
(10) Pub. No.: US 2021/0163192 A1
(43) Pub. Date: Jun. 3, 2021

(54) DOSING VALVE AND FILLING MACHINE FOR DOSING FOOD PRODUCTS

(71) Applicant: ALBERT HANDTMANN MASCHINENFABRIK GMBH & CO. KG, Biberach (DE)

(72) Inventors: Bernd MAILE, Oggelshausen (DE); Armin KIBLER, Eberhardzell (DE); Andreas KIBLER, Weingarten (DE)

(21) Appl. No.: 17/110,191

(22) Filed: Dec. 2, 2020

(30) Foreign Application Priority Data
Dec. 3, 2019 (EP) 19 213 078.9

(51) Int. Cl. B65D 47/30

(52) U.S. Cl. CPC B65D 47/30

(57) ABSTRACT

The disclosure relates to dosing valve for dosing liquid or paste-like masses, in particular food products, with a movable valve element which opens and closes a valve opening through which a portion is discharged, where the valve element comprises elastic material at its end region which when viewed in the closing direction is the leading one.

### CROSS REFERENCE TO RELATED APPLICATION

The present application claims priority to European Patent Application No. 19 213 078.9, entitled “DOSING VALVE AND FILLING MACHINE FOR DOSING FOOD PRODUCTS,” and filed on Dec. 3, 2019. The entire contents of the above-listed application is hereby incorporated by reference for all purposes.

### TECHNICAL FIELD

The disclosure relates to a dosing valve for dosing liquid or paste-like masses, such as food products, as well as to a filling machine with such a dosing valve.

### BACKGROUND AND SUMMARY

In the food industry, such valves are attached to production systems and machines, for example, vacuum filling machines, for dosing liquid and paste-like masses which can also contain chunky bits. Such a dosing valve is used to fill containers such as bowls, deep-drawn trays, etc.

Such dosing valves open by use of a drive at the start of the discharge process of the product to be delivered and close after the end of the portion to be discharged. The product is there defined, portioned, and separated. As a matter of principle, the valve is used to the extent possible at the end of a piping, directly at the outlet of a filling device.

Different valve types are employed depending on the product and the application.

Valves with a discharge piston are often used, for example, as disclosed in EP2215912. The product is fed into the valve from the side in a T-member. A piston is moved axially in the vertical axis, thereby opening or closing the inlet.

Valves with a taper at the outlet (nozzle) are often configured as seated valves. To close the valve, a plunger is moved axially until it rests on the edge of the nozzle and thereby closes the valve.

In another variant, the piston is not moved axially but radially (rotary piston valve). The valve can be opened or closed by rotating the piston due to the arrangement of the inlet and the outlet in the housing and the connecting channel in the rotary piston.

The diameter of the outlet opening of the valve is typically large enough that one can reach into the outlet opening, for example, with a finger. The valves in the prior art are configured such that, when the finger has reached the hazard region, it can be pinched and severely squeezed or severed. The reasons for this are the high closing forces and the configuration of the closing edges. It must therefore be prevented by way of safety clearances, mechanical baffles, protective enclosures, safety sensors, etc. that the finger can reach the hazard region, also referred to herein as the squeezing region.

However, these safety measures have a negative effect on the workflow for various reasons; in particular, such measures have a disadvantageous effect on production speed, handling, accessibility, gentleness to products, etc. It is often structurally not possible to provide mechanically separating protective devices.

FIG. 6 shows, for example, a dosing valve according to prior art, with a piston 2 which can be moved downwardly, in a tube 9 for closing valve opening 3. Edge K moves downwardly in pipe 9 while a finger can be inserted through opening 3 as far as inlet pipe 7. The finger can therefore be squeezed between movable valve element 2 and housing 5, e.g., the cutting edge in the transition region from inlet pipe 7 to pipe 9, where the cutting edge adjoining the lower surface of inlet pipe 7 and edge K are disposed on opposite sides of the squeezing region, but are laterally offset from one another, such that a finger is subjected to a shear force. FIG. 7 shows a prior art valve configured as a seated valve in which a plunger 2 is moved in the direction of valve opening 3. The finger can there be squeezed between the leading end of valve element 2 and housing 5 which tapers towards valve opening 3, so that serious injuries are likewise possible.

Proceeding from there, the present disclosure is based on the object of providing a dosing valve for dosing food products which may improve safety for the operating staff in a simple manner.

This object is satisfied according to the disclosure.

The dosing valve according to the disclosure comprises a movable valve element which opens and closes a valve opening through which a portion is discharged.

The valve element comprises elastic material at its end region which when viewed in the closing direction is the leading one.

This means that if, for example, a finger reaches through the valve opening into the interior of the valve housing when the valve element moves in the closing direction, the elastic material can easily adapt to the geometry of the finger upon contact with the finger thereby enabling an even distribution of force. According to the present disclosure, the dosing valve is therefore designed and configured in such a way that there may be a reduced risk of injury to the finger when the hazard region has been reached. Due to the fact that the elastic material is arranged in the leading end region, an elastic material can also advantageously serve as sealing material for sealing the valve opening.

The leading end region may extend at least 5 mm to 20 mm upwardly in the axial direction from the lower end.

Alternatively or in addition, the elastic material can also be arranged on the inner side of the valve housing, namely at a location where a finger can be squeezed by the valve element moving in the closing direction. In particular in the case of a seated valve, the elastic material may be arranged at an edge region around the valve opening, e.g., in the nozzle region or, in the case of valves that have valve closure pistons, in a region of a transition from an inlet line to a cylindrical pipe section in which the valve element is moved to close the valve opening.

In the case of a rotary piston valve, the elastic material can be arranged in the region of a side surface of the valve opening, e.g., the side surface which is facing a direction opposite the closing direction.

The possible contact area in the squeezing region is advantageously enlarged in order to maximize the distribution of force onto the finger and to thereby minimize the surface pressure. This means that there are no sharp edges that could sever a finger.

This is implemented in particular in such a way that the diameter of the valve element in the end region of the valve element decreases in the closing direction. In particular, a side contact surface that is inclined toward the closing direction of the valve element can then arise which in the event of a squeezing rests flat on the finger and can thereby minimize the pressure on the finger. Alternatively, the end region of the valve element can also be formed to be convex. The surface opposite the side contact surface of the valve element, e.g. the nozzle-shaped edge region around the valve opening can then be concave.

According to an embodiment, a squeezing region is defined by a side contact surface of the valve element that is inclined in the closing direction of the valve element and a side contact surface of the valve housing that is inclined toward the closing direction of the valve element, where the surfaces are disposed opposite one another or are arranged laterally offset from one another on opposite sides of the squeezing region. The pressure exerted on a finger can be minimized by the side contact surfaces.

Due to the fact that a squeezed finger is bordered by two surfaces, for example, the pressure exerted on the finger can be minimized as compared to sharp edges.

The squeezing region is understood to mean the region between the valve element and the valve housing in which an elongate finger can be squeezed due to the valve element moving. The point of squeezing can either be configured such that the finger is squeezed between the leading region of the valve element and an oppositely disposed region or between the leading region of the valve element and a region of the valve housing laterally offset thereto, for example, the lower surface of a feed line or a beveled cutting edge, so that the finger would be exposed to a shear effect.

In particular, the valve housing can have a side contact surface on its inner side which extends obliquely to the closing direction of the valve element and against which a squeezed finger bears when it is squeezed by the valve element, where the side contact surface can be arranged, for example, in the following regions:

in an edge region around the valve opening, e.g., the side contact surface is arranged in the form of a nozzle around the valve opening; in the closed state of the dosing valve, the side contact surface is disposed opposite the end region of the valve element,
on a side surface of the valve opening; for example, the surface of a valve opening which, in the case of a rotary piston valve, is directed to one side opposite to the direction of rotation or the direction of closing,
in a transition region between a feed line and a cylindrical pipe section in which the valve element is moved—for example, in the lower pipe surface of the feed line which opens into the pipe section at an angle of less than 90°, in particular of 15°-60°, or into a beveled cutting edge.

The dosing valve is advantageously controlled by a control device in such a way that the closing force is limited to a predetermined value, in particular to a value<135 N. This, for example, in combination with the aforementioned measures, may also serve to help reduce a risk of injuries.

According to an embodiment, the dosing valve is configured as a seated valve and comprises an axially movable plunger as a valve element which closes a valve opening arranged at the lower end of a conically tapering nozzle It is particularly advantageous in such a valve arrangement that a side contact surface is enlarged by the conically tapering nozzle of the valve. A risk of injuries may further be reduced if the tip of the movable plunger that comprises elastic material, in particular is configured as a rubber tip. If the tip of the plunger then also tapers downwardly, the contact surface is also enlarged at this point, which further minimizes the pressure.

In a further embodiment, the valve element is constructed in such a way that it has an axially movable discharge piston which opens and closes the valve opening in an inlet pipe. If a finger enters through the valve opening there up to the inlet pipe, then a risk can be reduced, for example, by the elastic material at the leading end of the discharge piston, e.g., the elastic piston tip, that injuries occur. If the end region of the discharge piston then has an inclined side contact surface, for example, as described above, and the transition region from the inlet pipe to the cylindrical pipe is also beveled, then this further increases protection.

It is also possible that the dosing valve is configured as a rotary piston valve and comprises a rotary piston as a movable valve element which opens and closes the opening by rotation. According to the present disclosure, the use of the elastic material can here as well help reduce a risk of injury for a finger inserted through the valve opening during the closure.

The elastic material is advantageously in particular a material from the group of elastomers, for example.

The elastic material has in particular a hardness of 30-80 Shore A according to DIN ISO 7619-1.

Advantageously, the pressure on the squeezed object, in particular the finger, should not be greater than 60 N/cm².

The elastic material advantageously closes the valve opening and thereby leads to a particularly good seal. This means that the elastic material can also serve as sealing material.

The disclosure also relates to a filling machine with a dosing valve, where the dosing valve is arranged at the end of an outlet pipe of the filling machine.

### BRIEF DESCRIPTION OF THE FIGURES

The present disclosure shall be explained below in more detail with reference to the following figures.

FIG. 1 schematically shows a first embodiment according to the present disclosure.

FIG. 2a shows the embodiment shown in FIG. 1 in a first closure position.

FIG. 2b shows the embodiment shown in FIG. 1 in a second closure position.

FIG. 2c shows the embodiment shown in FIG. 1 in a third closure position.

FIG. 3 shows a further embodiment according to the present disclosure.

FIGS. 4a to c show the embodiment shown in FIG. 3 in different closure positions.

FIGS. 5a to c show a further embodiment according to the present disclosure in different closure positions.

FIGS. 6 and 7 show dosing valves according to prior art.

### DETAILED DESCRIPTION

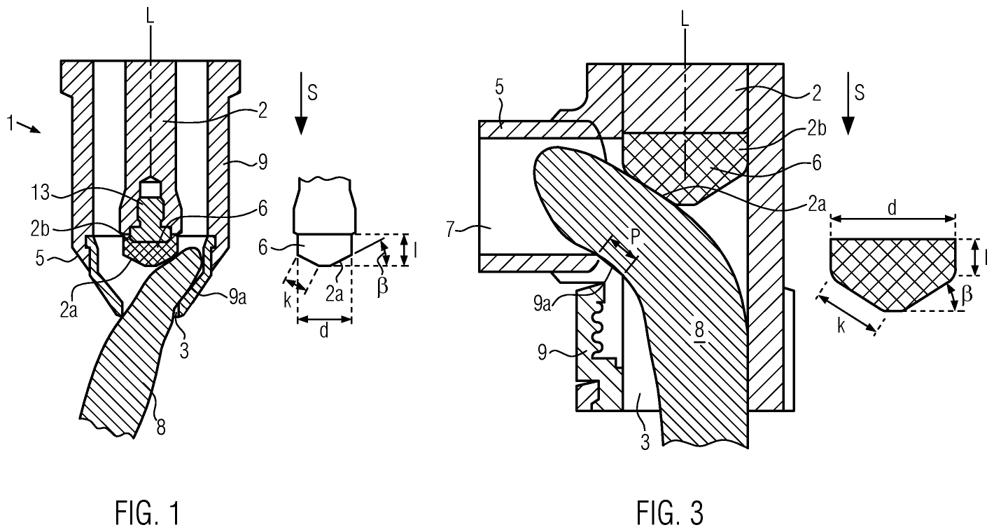

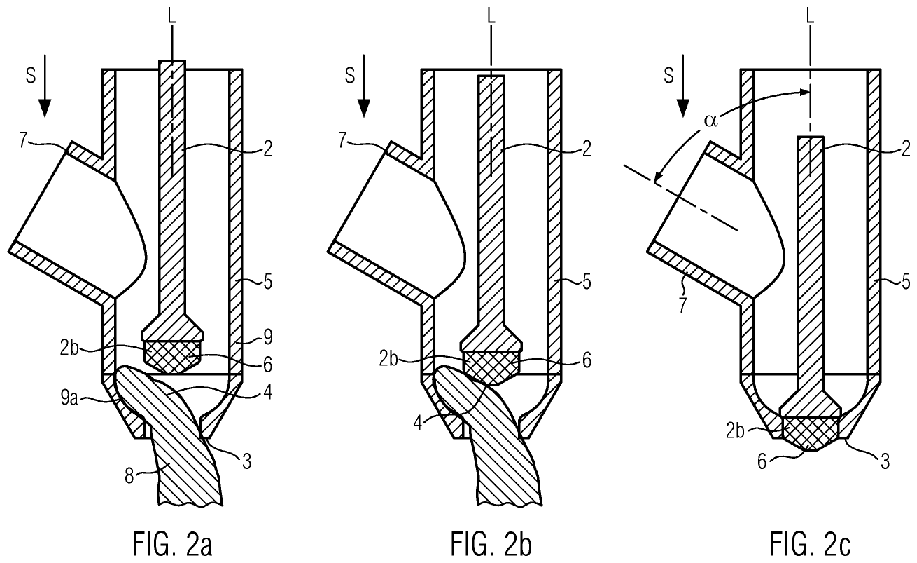

FIGS. 1 and 2a, 2b, 2c show an embodiment of a dosing valve 1 according to the present disclosure.

This dosing valve 1 is configured as a seated valve and comprises an inlet pipe 7 which is connected, for example, to a piping of a filling machine that delivers a strand of food product. In particular dosing valve 1 is used for dosing liquid and paste-like masses which can also contain chunky bits. Such a dosing valve 1 is used in particular to fill containers such as bowls, deep-drawn trays, etc.

Inlet pipe 7 opens into a pipe 9 which at its lower end comprises a valve opening 3 through which the food product is discharged in individual portions. Dosing valve 1 there comprises a movable valve element 2 which can be moved up and down in pipe 9 and can close valve opening 3 in closing direction S. Valve element 2 moves in a direction opposite to the closing direction by way of a drive in order to open valve opening 3. After the product to be delivered has been discharged, valve element 2 then moves downwardly again.

The inlet or inlet pipe 7 opens into pipe 9 at an angle α of <90°, in particular of 15°-60°.

Valve opening 3 may have an area in a range of 50 mm²-2000 mm², e.g., it is large enough that a finger 8 can reach into the opening.

As can be gathered in particular from FIG. 1, valve element 2 comprises elastic material 6 on its end region 2b which when viewed in closing direction S is the leading one. The elastic material is, for example, a material from the group of elastomers. The elastic material has in particular a hardness of 30-80 Shore A according to DIN ISO 7619-1.

Leading end region 2b may extend at least by a length 1 of 5 mm-20 mm from the lower end upwardly in the axial direction, e.g., in a direction opposite to the closing direction.

This dimension is sufficient to protect a finger 8 that reaches a squeezing region 4 between valve element 2 and housing 5.

This means that if, for example, a finger 8, presently test finger 8, reaches through valve opening 8 into the interior of valve housing 5, elastic material 6 can easily adapt to the geometry of finger 8 upon contact with finger 8 and thereby enable an even distribution of force. There is therefore a reduced risk of injury to finger 8 when the hazard region has been reached. Due to the fact that the elastic material is arranged in the leading end region, elastic material can additionally and advantageously serve as sealing material for sealing valve opening 3. Elastic material 6 can be adhesively bonded to valve element 2 or fastened to the upper part of valve element 2 in a removable manner by way of a fastening device 13, so that it can be replaced when worn.

The possible contact surface in squeezing region 4, e.g., between valve element 2 and valve housing 5, is advantageously enlarged in order to maximize the distribution of force on finger 8 and therefore to minimize the pressure on the finger.

As can be seen from FIGS. 1 and 2, this is achieved in that diameter d of valve element 2, e.g., elastic material 6, decreases in closing direction S, e.g., the outer contour tapers downwardly. In particular, an enlarged circumferential side contact surface that is inclined toward closing direction S of valve element 2 can then arise which, in the event of squeezing, rests flat on finger 8 and can thereby minimize the pressure on the finger.

Diameter d then decreases, for example, from 20-50 mm to 0-30 mm. Height k of the inclined circumferential side contact surface is, for example, in a range of 10-30 mm.

Angle β between a plane which is perpendicular to the closing direction or longitudinal axis L and side contact surface 2a may be in a range of 15°-60°. Elastic material 6 can alternatively also extends convexly downwardly in the direction of valve opening 3.

An end of valve element 2 thus configured provides very good protection.

If, as is presently case here, the lower region of dosing valve 1 is configured in such a way that housing 5 runs in a nozzle-shaped manner towards valve opening 3, an inclined side contact surface 9a arises in an edge region around valve opening 3 on which a finger rests when squeezed. This surface can be formed to be concave. This means that squeezing region 4 is defined by a side contact surface 2a of valve element 2 inclined toward closing direction S of valve element 2 and a side contact surface 9a of valve housing 5 inclined toward closing direction S of valve element 2, where the two side contact surfaces are presently disposed opposite each other.

Dosing valve 1 is controlled by a control device (not shown) which limits the closing force of valve element 2 to a predetermined value, in particular to a value<135 N. The above configuration results in a pressure on a squeezed object, for example a finger, which is no greater than 60 N/cm².

Although not shown in the figures, the valve housing as well can additionally or alternatively be equipped with elastic material in the squeezing region, in the embodiment in FIGS. 1 and 2, for example, in the nozzle-shaped tapering edge region around the valve opening. Such material can be adhesively bonded or vulcanized, for example, onto the inside of valve housing 5.

FIGS. 2a, 2b, 2c show the dosing valve in different closed positions. In FIG. 2a, dosing valve 1 is open. A finger 8 can there reach into the interior of the valve through valve opening 3. If the valve then closes, as shown in FIG. 2b, finger 8 can be squeezed. However, the risk of injury can be reduced due to the aforementioned configuration. In FIG. 2c, dosing valve 1 is closed, where elastic material 6 comes to rest in valve opening 3 in the lower end region. The valve element is configured to be somewhat wider in a region above the elastic material and protrudes laterally beyond the elastic material and thereby forms a sealing point to valve housing 5 for sealing valve opening 3.

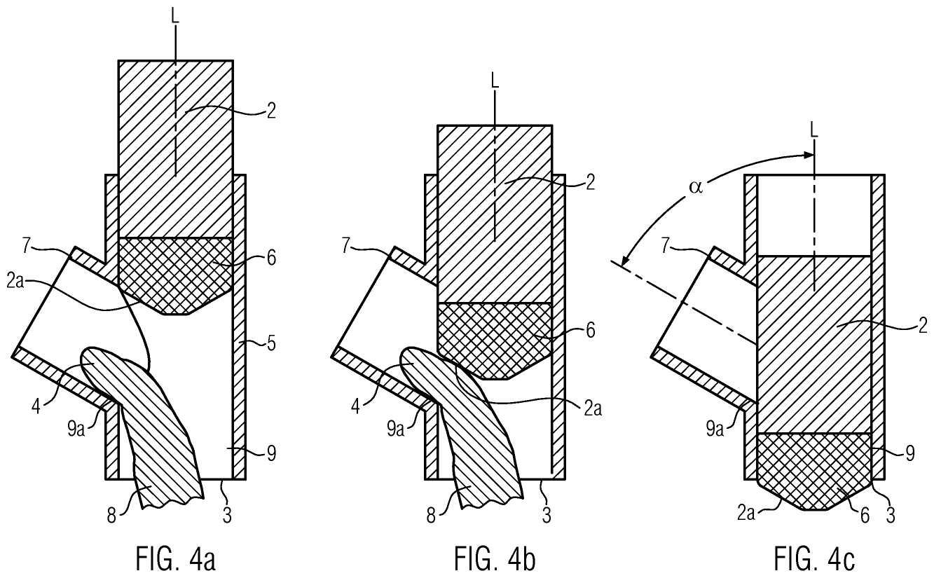

FIGS. 3 and 4a, 4b, 4c show a further embodiment according to the present disclosure which corresponds substantially to the first embodiment, so that corresponding details shall not be explained again. The only difference between the embodiments is that the dosing valve is configured in such a way that an axially movable discharge piston is provided as valve element 2 and opens and closes valve opening 3.

Like in the first embodiment, valve element 2 comprises elastic material 6 on its end region 2b which when viewed in closing direction S is the leading one, presently in the form of an elastic piston tip.

It can be seen in FIG. 3 that diameter d of valve element 2, e.g., elastic material 6, decreases in closing direction S, e.g., the outer contour tapers downwardly. An enlarged circumferential side contact surface 2a that is inclined toward closing direction S of valve element 2 can then arise which in the event of squeezing rests flat on finger 8 and can thereby minimize the pressure on the finger.

Diameter d there decreases, for example, from 20-50 mm to 0-30 mm. Height k of the inclined circumferential side contact surface is, for example, in a range of 10-30 mm.

Angle beta between a plane which is perpendicular to the closing direction or longitudinal axis L, respectively, and side contact surface 2a is in a range of 15°-60°. Elastic material 6 can alternatively also extend convexly downwardly in the direction of valve opening 3.

The discharge piston there closes valve opening 3 by moving into a region in pipe section 9 below feed line 7. During the downward motion, the discharge piston can sever or cut off the mass to be filled.

Like in the embodiment previously described, a finger is squeezed in the squeezing region, for example, by two side contact surfaces 9a, 2a, where the surfaces are presently arranged on oppositely disposed sides of the finger, but laterally offset from one another.

In the embodiment in FIG. 3, the transition region between feed line 7 and cylindrical pipe section 9, in which valve element 2 moves, is configured to be circumferentially planar e.g., presently in the form of a beveled cutting edge 9a which may have at least a dimension p of 10-30 mm and runs at an angle of 15°-60° to longitudinal axis L of the valve.

As shown in FIGS. 4a, 4b, 4c, however, inlet pipe 7 can also not open perpendicular to longitudinal axis L of the valve, but rather open into pipe section 9 at an angle of 15°-60°. This results in side contact surface 9a, on which a finger 8 comes to rest in squeezing region 4 in the lower region of the surface of inlet pipe 7.

FIG. 4a shows the dosing valve in the open position. FIG. 4b shows how valve element 2 moves in closing direction S and squeezes a finger 8.

FIG. 4c shows the valve in the closed position. As can be seen from FIG. 4c, valve element 2 is moved downwardly until a region of valve element 2, which is arranged above elastic material 6 and is made, for example, of metal, can seal pipe 9 below feed line 7.

In this embodiment as well, side contact surface 9a can be provided with an elastic material, even if this is not shown, which can additionally protect the finger.

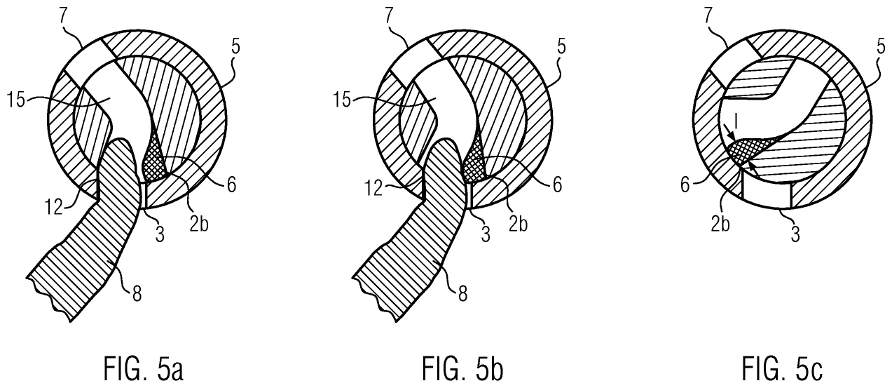

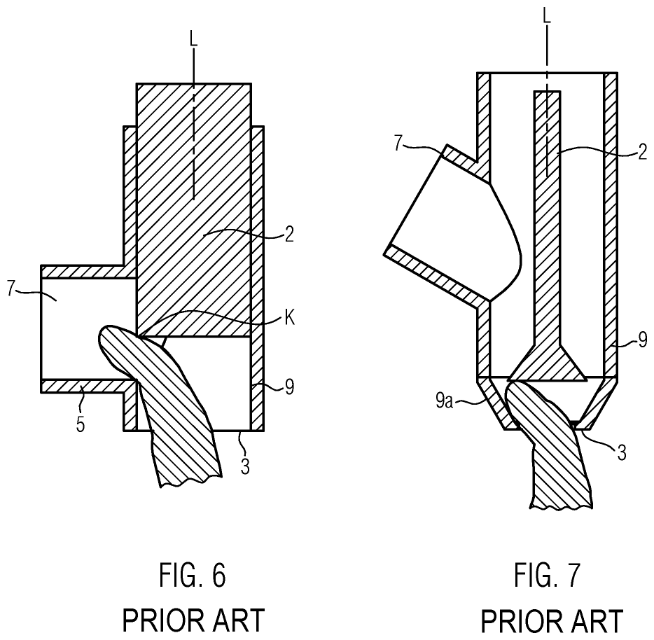

FIGS. 5a, 5b and 5c show a further embodiment according to the present disclosure which corresponds substantially to the previous embodiments, where the dosing valve is presently configured as a rotary piston valve and comprises a rotary piston as movable valve element 2 which opens and closes valve opening 3 by rotating it to and fro. Exactly like in the embodiments described above, elastic material 6 is then arranged in leading end region 2b of valve element 2.

The elastic material is presently, for example, wedge-shaped, e.g., the width 1 decreases towards the center. Width 1 is approximately in a range between 0-20 mm and can have a maximum dimension at the outer edge between 5 and 20 mm which decreases towards the center, in particular down to 0.

Like in the previous embodiments, a side contact surface 12 in opening 3, which faces on one side in a direction opposite closing direction S, can additionally be equipped with elastic material in order to minimize the pressure on the finger.

FIG. 5a shows the dosing valve in an open position, where a finger 8 has been inserted into valve opening 3. FIG. 5b shows how the valve closes and finger 8 is squeezed. FIG. 5c shows the valve in the closed position.

The present disclosure also relates to a filling machine (not shown) with a dosing valve according to the disclosure, where the dosing valve is arranged at the discharge end of the filling machine, e.g., is arranged at the beginning or at the end of a piping. Such a filling machine can be a vacuum filling machine with a hopper and a delivery pump for the mass to be filled, e.g. the food product.

The risk of injury can now be reduced according to the present disclosure by using elastic material 6. Since a squeezed finger may also further not rest on sharp edges, but on circumferential surfaces, the pressure and the risk of injury can be further reduced. Limiting the closing force further reduces the risk of injury.

1. Dosing valve for dosing liquid or paste-like masses with a movable valve element which opens and closes a valve opening through which a portion is discharged, wherein said valve element comprises elastic material at its end region which when viewed in a closing direction is a leading end of the valve element.

2. The dosing valve according to claim 1, wherein the elastic material is arranged on an inner side of a valve housing, where a finger is squeezable on said inner side by said valve element moving in the closing direction.

3. The dosing valve according to claim 2, wherein said finger is squeezable
on an edge region around said valve opening, or
on a side surface of said valve opening, or
in a region of a transition from a feed line to a cylindrical pipe section in which said valve element moves to close said valve opening.

4. The dosing valve according to claim 1, wherein a diameter of said valve element in said end region of said valve element decreases in the closing direction, where
the end region of said valve element has a circumferential side contact surface that is inclined toward the closing direction or is formed to be convex.

5. The dosing valve according to claim 1, wherein a squeezing region is defined by a side contact surface of said valve element that is inclined in the closing direction of said valve element and a side contact surface of a valve housing that is inclined toward the closing direction of said valve element, where said surfaces are disposed opposite one another or are arranged laterally offset from one another on opposite sides of said squeezing region.

6. The dosing valve according to claim 1, wherein a valve housing has a side contact surface on its inner side which extends obliquely to the closing direction of said valve element and against which a squeezed finger bears when squeezed by said valve element.

7. The dosing valve according to claim 6, where said side contact surface is
arranged in an edge region around said valve opening and, in the closed state of said dosing valve, is disposed opposite said end region of said valve element, or
is a side surface of said valve opening, or
is formed in a transition region between a feed line and a cylindrical pipe section in which said valve element moves opens into said pipe section at an angle of <90° or is in the form of a beveled cutting edge.

8. The dosing valve according to claim 7, wherein said cylindrical pipe section is a lower pipe surface of said feed line.

9. The dosing valve according to claim 7, wherein where said side contact surface is formed in the transition region between the feed line and the cylindrical pipe in which said valve element moves.

10. The dosing valve) according to claim 1, wherein said dosing valve can be actuated by a control device such that a closing force is limited to a predetermined value.

11. The dosing valve according to claim 10, wherein the predetermined value is a value less than 135N.

12. The dosing valve according to claim 1, wherein said dosing valve comprises an axially movable discharge piston as said valve element which opens and closes said valve opening.

13. The dosing valve according to claim 2, wherein said dosing valve is configured as a seated valve and comprises an axially movable plunger as said valve element which closes said valve opening arranged at the lower end of a conically tapering nozzle.

14. The dosing valve according to claim 1, wherein said dosing valve is configured as a rotary piston valve and comprises a rotary piston as a movable valve element which opens and closes said valve opening by rotation.

15. The dosing valve according to claim 1, wherein said elastic material is a material from the group of elastomers.

16. The dosing valve according to claim 1, wherein said elastic element has a hardness of 30-80 Shore A.

17. The dosing valve according to claim 1, wherein the pressure on a squeezed object is no greater than 60 N/cm².

18. The dosing element according to claim 1, wherein said elastic material closes said valve opening.

19. The dosing element according to claim 1, wherein the liquid or paste-like masses are food products.

20. Filling machine with a dosing valve according to claim 1, where said dosing valve is arranged at the discharge end of said filling machine.
